(19) United States
(12) Patent Application Publication
(10) Pub. No.: US 2007/0179978 A1
(43) Pub. Date: Aug. 2, 2007

(54) Systems and methods for anti-counterfeit authentication

(76) Inventors: Kin Kwok Lee, Hong Kong (HK); John Anthony Leper, Santa Monica, CA (US)

Correspondence Address: BAKER & MCKENZIE LLP, Pennzoil Place, South Tower, 711 Louisiana, Suite 3400, HOUSTON, TX, 77002-2716, US

(21) Appl. No.: 11/598,830

(22) Filed: Nov. 14, 2006

Related U.S. Application Data
(60) Provisional application No. 60/735,900, filed on Nov. 14, 2005.

(51) Int. Cl. G06F 17/00

(52) U.S. Cl. 707/104.1

(57) ABSTRACT

Systems and methods for preventing counterfeit are described. Consumers are able to authenticate the products they wish to buy and also authenticate the sellers selling the products. Manufacturers or brand owners of the products are able to track and control the distribution of the products to prevent counterfeit and undesired parallel trade.

### CROSS-REFERENCE TO RELATED APPLICATIONS

This application claims the benefit of U.S. Provisional Application Ser. No. 60/735,900 filed Nov. 14, 2005, expressly incorporated herein by reference.

### BACKGROUND

This invention is generally directed to anti-counterfeit technologies, and more specifically to systems and methods for authenticating both commodities and parties involved in a commodity transaction.

There has been a persistent requirement for technologies that can help consumers to identify genuine and fake products. This is especially the case for the medication industry. On the one hand, consumers feel the need to reliably know if the products they are going to buy are genuine or not. On the other hand, manufacturers also feel the need to track their products in the distribution chain to make sure their products are distributed and traded in a lawful manner by authorized traders.

### SUMMARY OF THE INVENTION

One of the objectives of this invention is to provide systems and methods by which consumers may reliably determine whether a desired product is genuine or not. A further objective of this invention is to provide systems and methods by which a manufacturer may track the distribution of its products.

In an aspect of this invention, a system is provided comprising a server and a user terminal. A consumer who is going to buy a product at a retail point may use the terminal to verify the authenticity of both the product and the qualification of the retail point by communicating with the server.

In a further aspect of this invention, a system is provided comprising a server and a user terminal. The original manufacturer or a qualified third party can use the server and user terminal to control the trade and distribution of products manufactured by the manufacturer.

In a further aspect of this invention, a system is provided by which two parties other than the original owner of a product or a batch of products can reliably exchange the products or the batch of products.

In a further aspect of this invention, a system is provided to generate codes for products and packages, the codes may be used in the authentication and tracking of the products.

In a further aspect of this invention, a system is provided adopting VoiceXML technologies by which users can use VOIP phones to authenticate products they wish to buy.

In a further aspect of this invention, various methods are provided which can be used, together with or separately from the systems of this invention, to facilitate consumers in verifying the authenticity of a desired product and the retail point at which the product is sold, and to facilitate original manufacturers in tracking the trade and distribution of their products, and to generate various codes to be used in such verification and tracking.

### BRIEF DESCRIPTION OF THE DRAWINGS

The present invention may be better understood, and its numerous objects, features, and advantages made apparent to those skilled in the art by referencing the accompanying drawings:

FIG. 1 shows a preferred embodiment of a system and method for generating codes to be used in this invention.

FIG. 2A shows the structure of a unique PID code.

FIG. 2B shows the formation of a PID code label.

FIG. 3 shows a PID code activation system and method.

FIG. 4 shows a batch ID code formation and structure.

FIG. 5 shows the formation of two exemplary batch ID code labels.

FIG. 6 shows a batch ID code generation and label printing system.

FIG. 7 shows a process of distributor and retailer authorization.

FIG. 8 shows an ex-factory system and method to keep the distribution record of batch ID codes.

FIG. 9A shows the structure and functional modules of a verification system and various access channels.

FIG. 9B shows an illustrative scheme of the information flow taking place in such a system.

FIG. 10 shows a batch ID code verification system.

FIG. 11 shows a batch ID code verification process.

FIG. 12 shows a process of the batch ID code verification through a PSTN telephone or mobile phone communication.

FIG. 13 shows a process of batch ID code verification through SMS.

FIG. 14 shows a batch verification process by document transmission.

FIG. 15 shows a distribution hierarchy table.

FIG. 16 shows the batch ownership exchange process.

FIG. 17 shows the general principle of PID double authentication through accessing a third party database system.

FIG. 18 shows a double authentication process with a registration option for the buyer.

FIG. 19 shows a prior-art telephone query system.

FIG. 20 shows a process in which VOIP phones are used in a query system.

FIG. 21 shows a query process illustrating the basic concept of a query system adopting VoiceXML according to an embodiment of this invention.

FIG. 22 shows a process applying a query system according to an embodiment of this invention to a verification mechanism of this invention.

FIG. 23 shows the configuration of a query system adopting VoiceXML according to an embodiment of this invention.

FIG. 24 shows an embodiment of the VoiceXML server 2301 as shown in FIG. 23.

FIG. 25 shows an exemplary operation process for a VoiceXML system as shown in FIG. 23.

FIGS. 26-28 show various forms used in a paperwork-based authentication process.

### DESCRIPTION OF THE PREFERRED EMBODIMENTS

The following sets forth a detailed description of the best modes contemplated for carrying out the invention. The description is intended to be illustrative of the invention and should not be taken to be limiting.

The basic concepts of this invention include assigning a unique identifier to each product to be put in the distribution chain and market, and establishing a third-party system for merchants and consumers to verify the authenticity of the product they are going to take possession of.

### Product Identification Code Generation

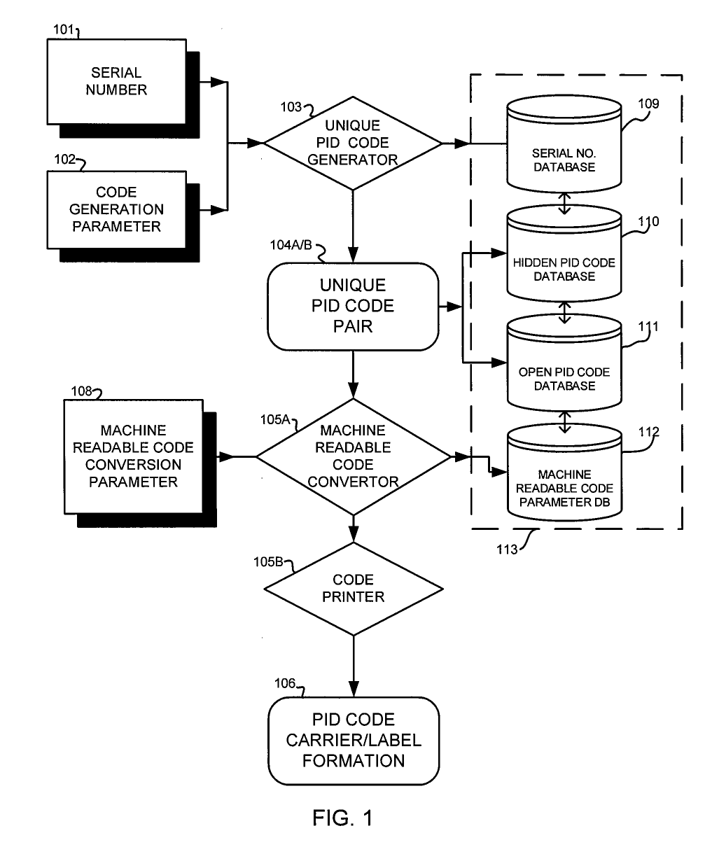

FIG. 1 shows a preferred embodiment of a system and method for generating codes to be used in this invention.

In this embodiment, the system is able to generate and store Product Identification (PID) codes. The PID codes are assigned to products. The PID code for each product may be unique. Once a PID code is applied to a product, the system activates the code.

The PID code generation system FIG. 1 comprises 4 major components, namely a unique PID code generator 103, a machine-readable code generator 105A, a code printer/maker 105B and a PD code database 113. The PD code database 113 comprises four relational databases, namely a serial number database 109, a hidden PID code database 110, an open PID code database 111 and a machine-readable code database 112.

It is should be noted that, the serial number database 109, hidden PID code database 110, open PID code database 111 and machine-readable code database 112 may be four separate databases within the PID code database 113, or four tables within one database of the PID code database 113.

### PID Code Structure

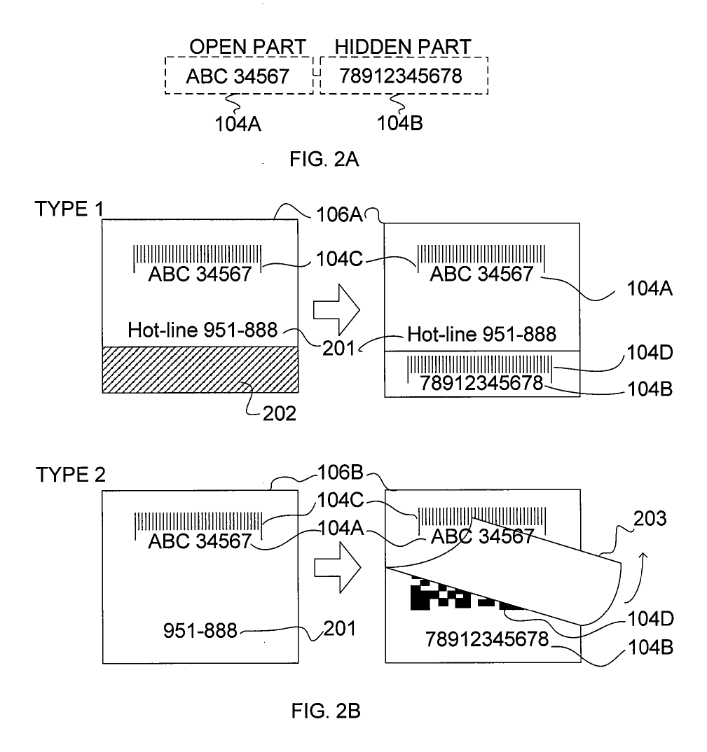

FIG. 2A shows the structure of a unique PID code. A unique PID Code comprises two parts: (1) an open part 104A and (2) a hidden part 104B. In this specific embodiment, both parts are composed of 4 to 20 or more alphanumeric or numeric code and unique in nature. Other lengths for the two parts are conceivable. The relationship between the open part 104A and hidden part(s) 104B may be a one-to-one relationship in order to make such a PID code pair 104A/B unique, and it does not matter whether they are combined or separated. Other relationships for the two parts are also conceivable as long as the combination of the two parts form a unique PID code. Alternatively, the PID code pair 104A/B may also appear as a single PID Code without being broken into two parts. Hereinafter, numerals “104A/B” are used to designate a “PD code pair” or a “PID code.”

### PID Code Generation Method

FIG. 1 also shows an exemplary method of generating, storing and printing a series of unique PID codes 104A/B. A unique PID code 104A/B may be generated by inputting a serial number 101 and one or more code generator parameters 102 into the unique PID code generator 103. The unique PID code generator 103 may comprise an algorithm that, according to the input parameters 102, converts a serial number 101 into a unique alphanumeric or numeric code, PID code 104A/B. There are known mathematical algorithms that may be used in this step to generate a unique PID code from a serial number and other parameters. This process may be repeated to produce a set of unique PID codes from a set of serial numbers. Alternatively, a set of serial numbers may be processed in a batch to produce a set of unique PID codes. The generated PID codes may appear randomly arranged. As a result, for any unique PID code 104A/B there exists a corresponding unique serial number 101, establishing a one-to-one relationship. Any alteration of the code generation parameters 102 may change the resultant PID code 104A/B, even if the serial number 101 remains unchanged.

In an embodiment in which a PID code consists of a hidden part and an open part, such a serial number 101—PID code 104A/B relationship may be recorded in a relational database, the serial number database 109, hidden PID code database 110 and open PID code database 111. Alternatively, if PID codes are not broken down, there might be one PID code database for them.

The generated PID code 104A/B may also be input into a Machine-readable Code Converter 105A and then converted into a Machine-readable code. The formation of the machine-readable code may be determined by one or more machine-readable conversion parameters 108. The machine-readable code may be in the form of a 1-dimension (1-D) barcode or 2-dimension (2-D) barcode, or an RFID tag that may be read by a suitable reader or scanner. RFID technology is well known in the art and its detailed description is omitted here.

The generated machine-readable codes and parameters 108 may be recorded in a machine-readable code database 112. Understandably, since the machine-readable code may be generated from the unique PID code, the machine-readable code database 112 may be associated with databases 110 and 111.

Then a code printer or maker 105B may be used to print the machine-readable code or PID code 104A/B onto a PID code label 106A/B as step 106 indicates. Alternatively, both the machine-readable code and PID code 104A/B, in alphanumeric or numeric form, may be marked directly on the product or object to be identified, so that the product or object becomes the carrier of such unique PID code 104A/B. The marked PID code or PID label 106A/B turns out to be the only identification of the product or object to be identified.

### PID Code Label/Carrier

FIG. 2B shows the formation of a PID code label 106A/B. The function of a PID code label 106A/B or PID code marking is to provide identifiable information for anyone who would like to verify the authenticity of the object or product. As discussed below with respect to an embodiment, this verification may be done by accessing a third-party authentication database. The PID code 104A/B may be openly marked or printed on the product or object to be identified. Alternatively, the open PD code 104A may be openly printed on the PID code Label 106A/B while the hidden part of the PID code 104B may be printed onto the label 106A/B but concealed. Concealing the hidden part PID code 104B or not is at the discretion of the manufacturer of the product in view of his operational or business considerations.

The PID code label or carrier may have the following characteristics for tamper-proofing and identification purposes.

(1) Format

As FIG. 2B indicates, the PID code 104A/B may be printed or marked on a product in machine readable code, or alphanumeric or numeric code, or other formats known in the art.

The object of a machine readable PID code 104C and 104D is to provide a convenient and efficient way for anyone who is equipped with a corresponding reader or scanner to easily input the code and verify the authenticity of the product. The machine readable code 104C and 104D may be in 1-D barcode or 2-D barcode form.

The object of an alphanumeric or numeric PID code 104A and 104B is to provide an accessible means for anyone who does not have a corresponding machine-readable code scanner or reader to still be able to verify the authenticity of a product or object by inputting the PID code in such form.

(2) Hidden PID Code

As FIG. 2B indicates, a PID code 104B may be hidden on the PID code label 106A/B. The object of the hidden PID code 104B is to provide a tamper-proof protection for the object or product to be identified. Such a design makes sure that the PID code 104B may be verified only once. Once the PID code 104B is opened, it may alert a person (e.g., a potential customer) that the PID code 104B has been exposed previously. The alerted customer, thus, has reason to suspect the integrity of the label, and that the product, may have been tampered with.

In the illustrated embodiment, the PID code 104B is hidden by a scratch-able coating 202, a tear-able layer 203 and a printing inside product packaging.

As FIG. 2B illustrates, in the scenario of Type 1, the hidden PID code, both in the machine-readable code form 104D and numeric form 104B, may be covered by a scratch-able coating 202. Once the coating 202 is irreversibly scratched away, the PID code 104B may be exposed.

In the scenario of Type 2, the hidden PID code, in both the machine-readable code form 104D and numeric form 104B, may be covered by a tear-away layer 203. Once the layer 203 is irreversibly unsealed, the PID code 104B may be exposed.

Under conditions where a PID label 106A/B is not applicable, the hidden PID code 104B may be marked or printed directly inside the packaging of a product or object. Once the product packaging is opened, the PID code 104B may be revealed and then verified.

(3) Open PID Code

As FIG. 2B illustrates, an open PID code 104A may be printed on the PID code Label 106A/B. The objective of the open PID code 104A is to enable the PD code activation process to be discussed below. The open PID code 104A may be mainly presented in the machine-readable code form 104C, for the sake of efficient input during the activation process.

As discussed above, in some embodiments, the PID code is not separated into an open code and a hidden code. The whole PID code may be open or hidden.

(4) Other Anti-Counterfeit Printing or Forensic Marking

Apart from the PID code 104A/B printed on the PID label 106A/B, other anti-counterfeit print or forensic markings may also be applied to the label 106A/B in order to enhance the effectiveness of anti-counterfeiting methods.

(5) RFID Tag

In order to provide more information in the PID label 106A/B, a Radio Frequency Identification (RFID) tag may also be attached on the back of the label 106A/B. The RFID tag may store information of the hidden PID code 104B as well as other product information in order to enhance the data inputting and verification efficiency through an RF reader, meanwhile providing a conventional means for anyone who does not have a specific RF reader to read relevant information to verify the product identification by inputting the PID code 104A/B printed on the label 106A/B.

### PID Code Activation

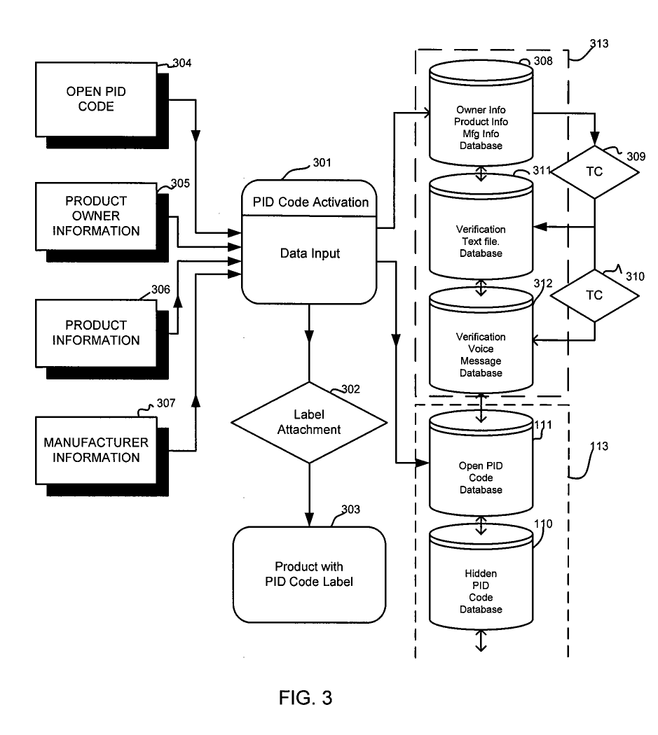

FIG. 3 shows a PID code activation system and method. The object of the activation process is to construct information for each PID Code 104A/B generated, so that when such a PID Code 104A/B is verified later by a consumer or merchant, the information of the verified PID code 104A/B may be revealed during the verification process. Before the activation process the PID code label 106A/B or the PID code 104A/B is meaningless. This arrangement is to provide operation flexibility for brand owners to decide which kinds of their products require the anti-counterfeiting protection of this invention.

(1) PID Code Activation System

As FIG. 3 shows, the PID code activation system comprises three major parts, a PID code activation application module 301, a verification information database 313, and a PID code database 113. The PID code activation application module 301 may be installed on a computer and may have a data connection to the verification information database 313 and PD code database 113. Such a data connection may be in any form known in the art, including but not limit to a Local Area Network (LAN), Wide Area Network (WAN) or Internet connection so that the databases 313 and 113 may be located locally together with or remotely away from the application module 301. The data may be transmitted in any applicable format and protocol known in the art.

The function of the application module 301 is to provide interfaces for brand owners to input all related information and to connect and update the databases 313 and 113. The related information includes open PD code information 304, product owner information 304, product information 306, and manufacturing information 307. All the information may be recorded, through a data connection or network, into the verification information database 313 and PD code database 113. The verification information database 313 comprises (a) a product identity information database 308 that contains all product information 306, ownership information 305 and manufacturing information 307, (b) a verification information text converter 309 that converts the registered data into appropriate presentation text format for being displayed in the form of SMS and online verification text display, (c) a verification result text file database 311 that records all text files generated by the verification text converter 309, (d) a text-to-speech (TTS) converter 310 that converts the generated verification result text files into verification result voice files, and (e) a verification result voice file database 312 that contains all voice files generated by the TTS converter 310.

The PID code database 113 may be updated by the application module 301 and may create a relational link to the verification information database 313.

(2) PID Code Activation Method

Even after a PID Code is generated, it does not represent any meaning or identity. Through the PID code activation process, the product/brand owner may give meaning to the PID code that may be directly applied to an object or product, as well as a PID code label.

The owner may decide to assign a certain set of generated PID codes to a type/line of product or object to be identified. Then the owner may open the PID code activation application module 301 and select open codes of the set of PID codes which may be applied to PID code labels. Alternatively, the PID codes may be marked directly on the product or object.

Once a specific PID code 104A/B is selected, the owner may then input:
(a) product owner information 305, indicating the original ownership status of the product to be identified,
(b) product information 306 that may be the information printed on the product packaging, including but not limit to, product name and product description or any information that may be found on the packaging of the product to be identified, and
(c) manufacturing information 307, including but not limited to, serial number, manufacturing/expiration date, or license number, etc. (this information may be printed at the moment of production on the product packaging accordingly).

After the above mentioned information is input, the application module 301 may connect and update the assigned open PID code 104A or full PID code 104A/B to the PID code database 113 that may be linked with the verification information database 313. Meanwhile, the input product owner information 305, product information 306, and manufacturing information 307 may also be updated to the product identity information database 308. The updated product identity information may then be converted into an appropriate presentation format for being displayed during the verification process by the verification text converter 309. Those converted text files may then be stored in the verification text file database 311. Once the activated PD code is verified, the system may retrieve corresponding verification result texts from the database 311 and the retrieved text files may be displayed in the form of SMS or online verification text display.

Optionally, the converted texts may also be sent to the TTS converter 310 that may convert the text files into sound files, in any available sound file formats. Such generated sound files may be stored in the verification voice message database 312. Again, if the activated PID code 104B is verified through telephone, the associated voice/sound file verification message may be played.

When a PID code is activated, a PID code label may be applied to the product to be identified as step 302 indicates. Then any product or object bearing such a PID code label may be regarded as having an identification mark. If the PID code is directly marked on the object or product to be identified, steps 302 and 303 are not applicable. This is because once the PID code is activated, the product and object of such PID code marking may be automatically regarded as having an identification record.

### Inside Code

In order to make the system difficult to crack, an inside code may be input along with the manufacturing information 307. This inside code may be unique or the same for the whole lot of products and in alphanumeric or numeric form. The inside code is like the rest of the manufacturing information 307, for example the lot number, that may be printed on the product packaging, right at the moment of production. Yet the major difference is that this inside code may be printed inside the product packaging. It may be found only when a consumer buys the product and opens the product packaging. When the consumer verifies the identity of the product, the verification feedback may also present this inside code for further assurance of the product authenticity.

### Batch ID Code Generation Method & System

A batch ID code is applicable to a collection of individual products that are packed in a case or box. Understandably, the meaning of “individual” or “batch” could be recursive. For example, in some cases, a box of multiple products may be regarded as an “individual” product, and a bigger case containing multiple boxes may be regarded as a batch. A basic requirement for batch ID codes is that they should be unique. They may be generated randomly or simply as serial numbers.

The object of batch ID code formation is to create a relational link between the PID code and batch ID code. This PID code-batch ID code link enables authorized distributors and retailers to verify, on a batch scale, products bearing activated PID codes, while consumers are likely to verify only individual products.

A batch ID code represents all individual unique PID codes within a package. Once the batch ID code is verified, it implies that all PID codes are also verified and this may be kept in the verification record. Such a batch scale verification process empowers distributors and retailers to protect their own interest by verifying the authenticity of the whole batch of products during a receiving process. Meanwhile, the batch scale verification action may prevent counterfeit and undesirable items from infiltrating the authorized distribution chain. Described below are the batch ID code structure, batch ID label, and systems and methods that enable the batch scale verification.

(1) Batch ID Code Structure

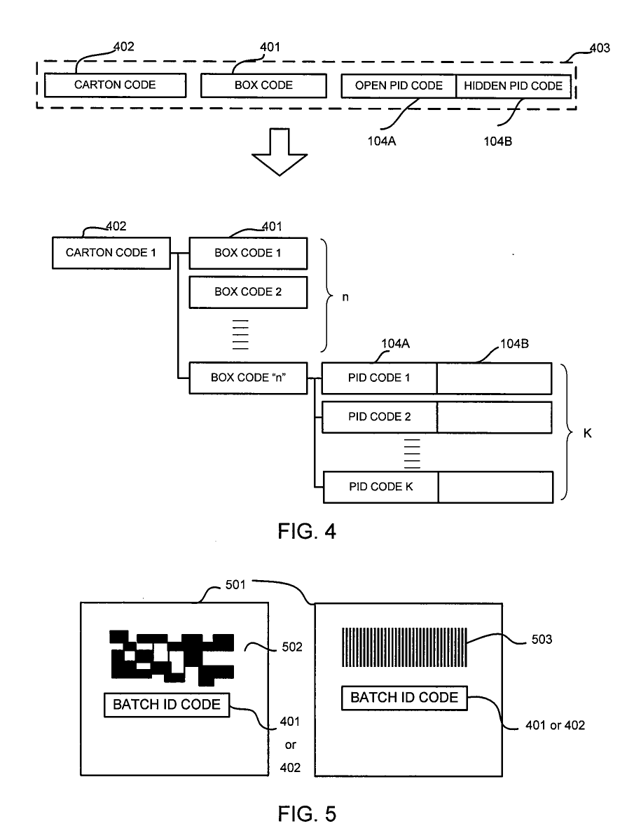

FIG. 4 shows the batch ID code formation and structure. The whole ID code hierarchy 403 comprises at least three sections of unique codes, a carton code 402, a box code 401, and a PID code 104A/B. They are unique in the form of individual existing, thus, making the ID code hierarchy 403 is unique for any individual product. In one embodiment there are two layers of packaging, but as can be perceived readily, the number of the sections may be determined by the number of layers of packaging as necessary. Further, in this embodiment, both the carton code 402 and the box code 401 may be batch ID codes.

More generally speaking, for the embodiment in FIG. 4, any of the carton code 402, the box code 401, or the concatenation of the two may be called a “batch ID code” depending on specific circumstances.

Such uniqueness of each section composes a code family tree, as depicted in FIG. 4, so that for any unique carton code 402, there are n unique box codes 401, from 1 to n. This represents that beneath carton code 1, there are n boxes of packaging with box code 1 to box code “n”. By the same token, beneath box code “n”, there are k products of PID codes from 1 to k. Therefore, once an authorized distributor verifies carton code 1, all box codes 1 to n and all PiD codes falling into such a family tree are verified collectively. This is the same for box code “n”; once it is verified by an authorized retailer, all PID codes 1 to K are also verified.

(2) Batch ID Code Label/Carrier

FIG. 5 shows the formation of two exemplary batch ID code labels 501. Each individual section of the batch ID code 403 may be printed at respective location. For example, the carton code 402 section may be printed on a carton code label 501 that may be applied to a carton box, and the box code 401 section may be printed on a box code label 501 that may be applied to a box packaging packed within a carton box.

Each batch ID code (e.g., the carton code 402 and box code 401) may be printed in two formats, (1) machine-readable code (2-D barcode 502 or 1-D Barcode 503) onto the batch ID label (e.g., carton code or box code label) under any applicable coding standard that may be convenient to the brand owner or proliferation, and (2) alphanumeric or numeric format of code 401/402. Alternatively or additionally, for the sake of operation efficiency, an RFID tag in which the batch ID Code 403 may be stored may be attached to the batch ID label 501.

### Batch ID Code Generation and Label Printing System

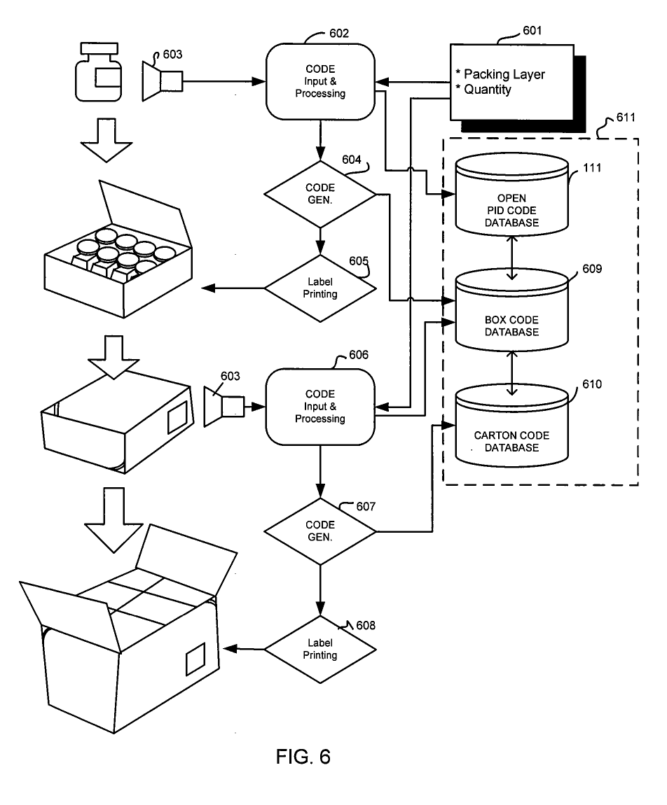

FIG. 6 shows a batch ID code generation and label printing system. The system comprises a code input device 602, a machine-readable code scanner 603, code input processing units 602 and 606, code generators 604 and 607, label printers 605 and 608, a packing layer setting interface 601 and a relational database 611. The relational database 611 may be composed of an open PID code database 111, a box code database 609 and a carton code database 610. All the units and modules may be installed on one computer or installed in different computers which may be connected by some kind of communication links such as LAN, WAN, Internet or wireless networks.

(1) Batch ID Code Generation and Label Printing Method

FIG. 6 also displays how a box code 401 and box code label 501 may be generated as well as how a carton code 402 and carton code label 501 may be generated. First the user determines how many products will be packed into a box and how many boxes will be packed into a carton, as well as how many layers of packing are involved. Once these parameters are set, such data may be sent to the code input and processing units (602 and 606).

According to the number of products that are to be packed into a box, the code processing unit 602 inputs a corresponding number of PID codes 104, in machine readable form on PID code labels 106 while passing through the machine-readable code scanner 603. The code processing unit 602 counts the number of PID codes 104A up to the pre-set quantity. Once the number of PID codes 104 reaches that quantity, the code generator 604 generates a unique corresponding box code 401. The newly generated box code 401, along with the input PID codes 104 may be stored into the relational database 611. Those input PID codes 104 may be registered inside an open PID code database 111 and the corresponding box code 401 in a box code database 609.

Meanwhile, the label printer 605 may convert the newly generated box code 401 into the machine readable format 502/503 and print the box code 401 in alphanumeric or numeric format and machine readable code format 502/503 on a box code label 501. The box code label 501 may then be applied to the box that may be packed with all those products with the PID code labels 106A/B scanned before. The box code label 501 sticking process may be done manually or mechanically.

By the same method, during the carton box packing process, the code input processing unit 606 may register box codes 401 scanned through a machine readable code scanner 603, and the preset quantity of the boxes may be packed into a carton box. When the input quantity of the box codes 401 reaches the preset level, a unique carton code 402 may be generated by a code generation unit 607. Those input box codes 401 may be registered into the box code database 609 and the corresponding carton code 402 may be registered into the carton code database 610.

Meanwhile, the carton code 402 generated may be converted into the machine readable format 502/503 by the label printer 608 that will print the carton code 402 in both machine readable format 502 and alphanumeric or numeric format 503 onto a carton code label 501. The carton label 501 may be attached to the carton box packed with boxes scanned before.

### Distributor & Retailer Authorization

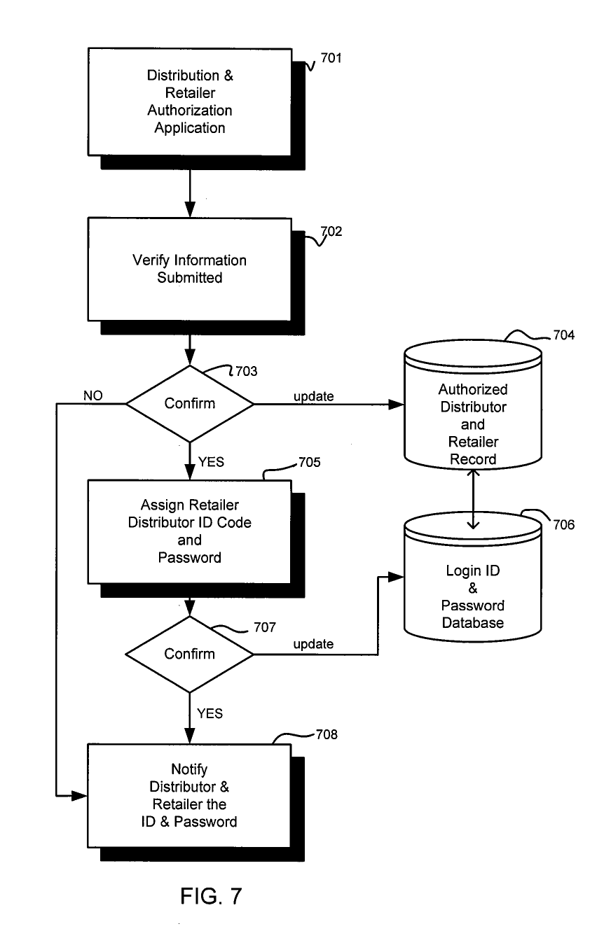

FIG. 7 shows the process of distributor and retailer authorization. The object of this process is to assure that only authorized parties have the right to verify and register the ownership to a batch of product which bears a batch ID code label. Therefore, the product/brand owner may first verify the legitimacy of the distributor and retailer who would like to verify the batch and to claim ownership of the batch.

(1) Authorized Party Application

For any distributor or retailer who would like to verify and claim ownership of a product batch bearing a batch ID label 501, he/she should apply for an Identity (ID) code and password first. The application process, as step 701 in FIG. 7 shows, may be done by submitting information via the Internet in digital form, or in a paper document form through FAX or mailing. Distributors and retailers may be required to submit their company information and business license for the brand/product owner to verify.

(2) Application Verification

After receiving the application information mentioned in step 701, the brand/product owner may verify the information submitted to make sure that the legal and business status of the applicants is valid, as Process 702 indicated. This process may be done using many different approaches, for example, by cooperation with relevant governmental offices.

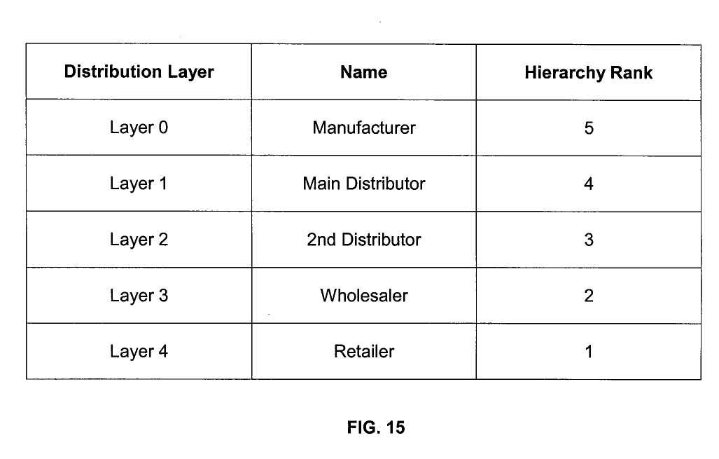

Then, if the legal and business status of the applicant is confirmed, at decision block 703, the applicant's company information may be updated to the authorized distributor and retailer record 704. Meanwhile, the brand/product owner may decide in which layer of a distribution hierarchy this distributor or retailer will be (FIG. 15). Otherwise, if the business and legal status of the business are in question, the brand owner may reject the application and notify the applicant.

(3) Assigning ID and Password

Once a distributor or retailer's business and legal status is validated at the decision process 703, the brand/product owner may assign an ID code and password to the accepted distributor or retailer at step 705. The ID code and password may be in any alphanumeric or numeric form. At step 707, the assigned ID and password are registered into the login ID and password database 706.

(4) Notify Authorized Parties

At step 708, then brand/product owner may notify the applicant that his application is accepted and sends the applicant the assigned login ID and password, through the Internet in digital form or through Fax or mail in document form, among other methods.

Ex-Factory Distribution Recording System and Method

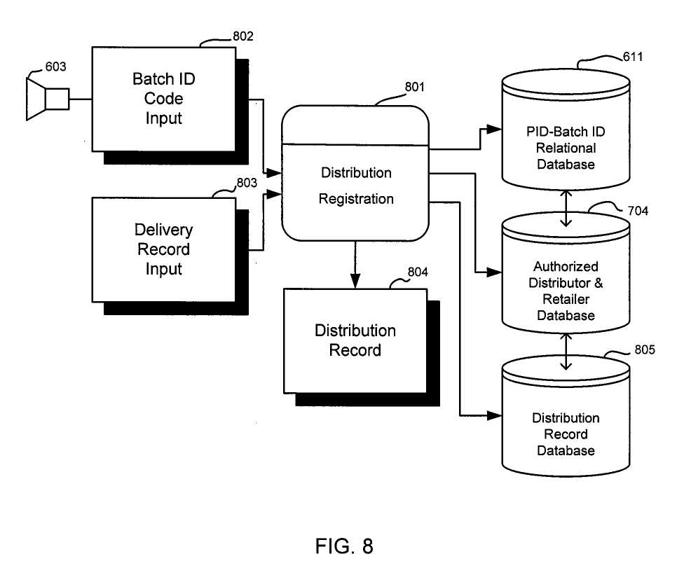

After finishing the distributor authorization process, the brand/product owner then may keep the record of each batch that bears a batch ID code label belonging to which authorized distributor. FIG. 8 shows the system and method to keep the distribution record of batch ID codes. The objective of such batch ID distribution recordkeeping is to record to which distributor or retailer a batch is distributed so as to trace the origin of each batch ID code to prevent counterfeits from entering the distribution chain. This process may provide help for counterfeiting investigative work.

FIG. 8 shows the ex-factory distribution recording system. The system may be composed of distribution registration application software 801 and a relational database. The application 801 comprises three major interfaces, namely a batch ID code input 802 that may be connected to a machine readable code scanner 603, a delivery record input 803 and a distribution record 804 for users to input and review data. The relational database may be composed of three databases, a PID and batch ID code database 611, an authorized distributor and retailer database 704 and a distribution record database 805. The link between the application 801 and the databases 611, 704 and 805 may be through any network known in the art, including but not limit to, Internet, LAN or WAN; or even local data linkage. This means that the application 801 and the relational databases 611, 704 and 805 may be located on one computer or on different computers situated in different remote geographical locations.

In order to make the batch ID codes traceable, the brand/product owner may utilize the machine readable scanner 603 to scan the batch ID code printed on the batch ID code label applied to the batch to be delivered as a code input. Alternatively, the batch ID code input process may be done manually. Then through the delivery record input module 803, the destination of delivery, including but not limited to, the distributor information, may be input. Such input data may be registered into the relational databases 611 and 704. From the data, a distribution record may be stored in the distribution record database 805. Through the distribution record module 804, the brand/product owner may review and print out the distribution record.

### Verification System & Channel

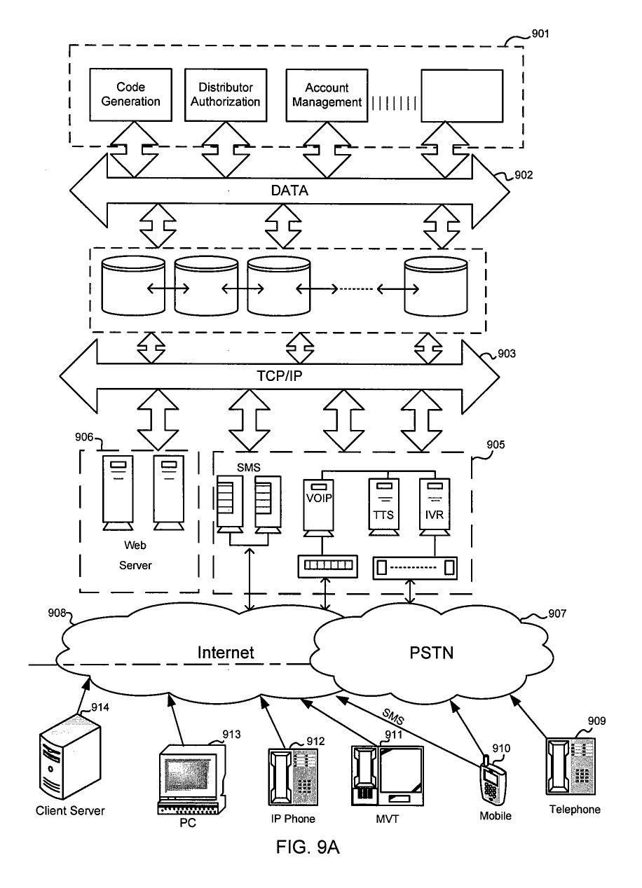

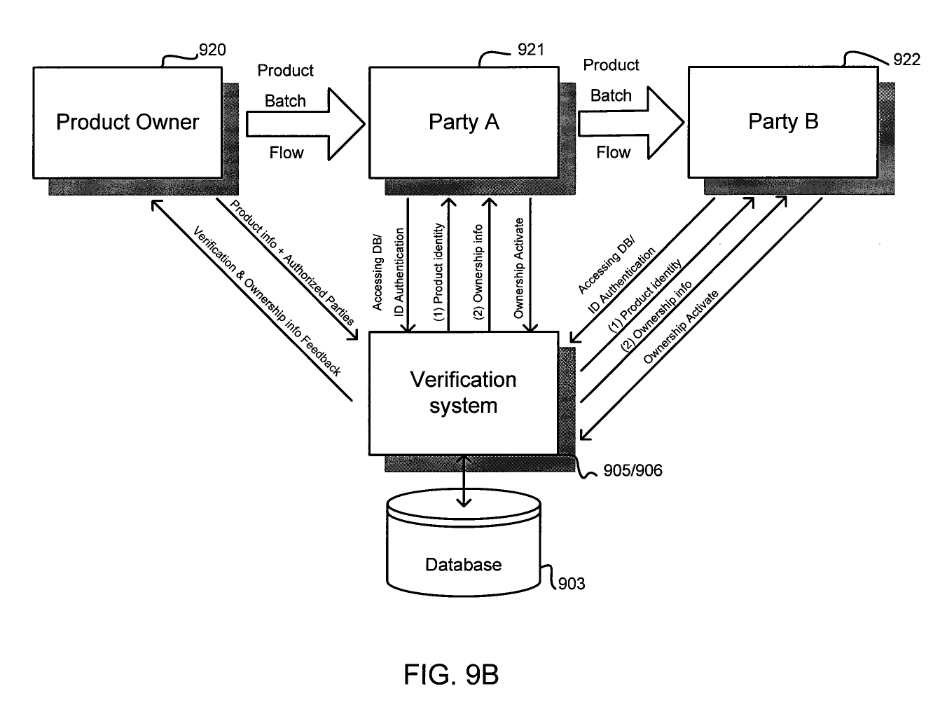

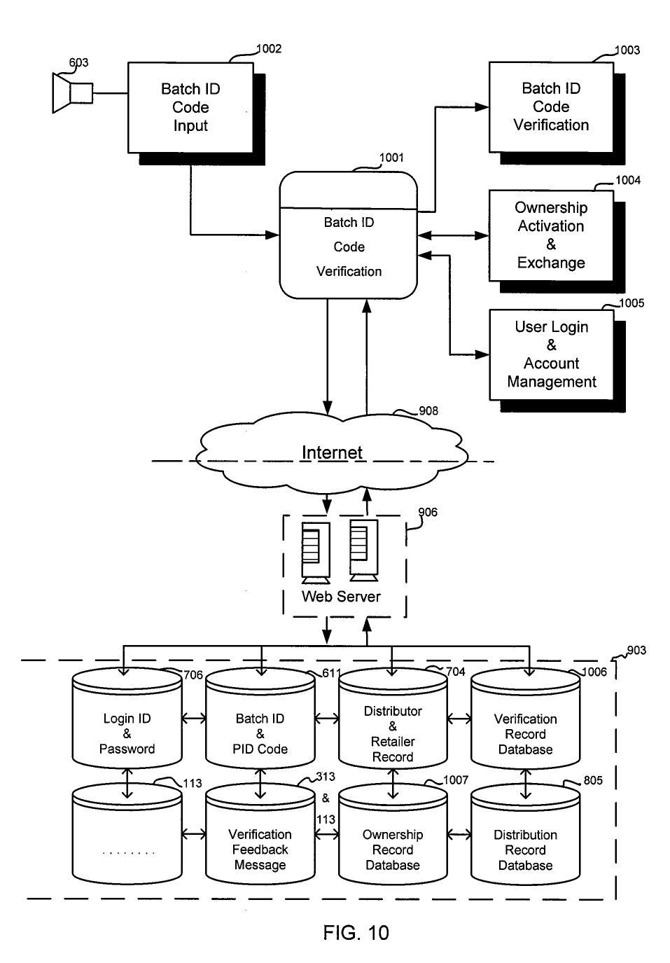

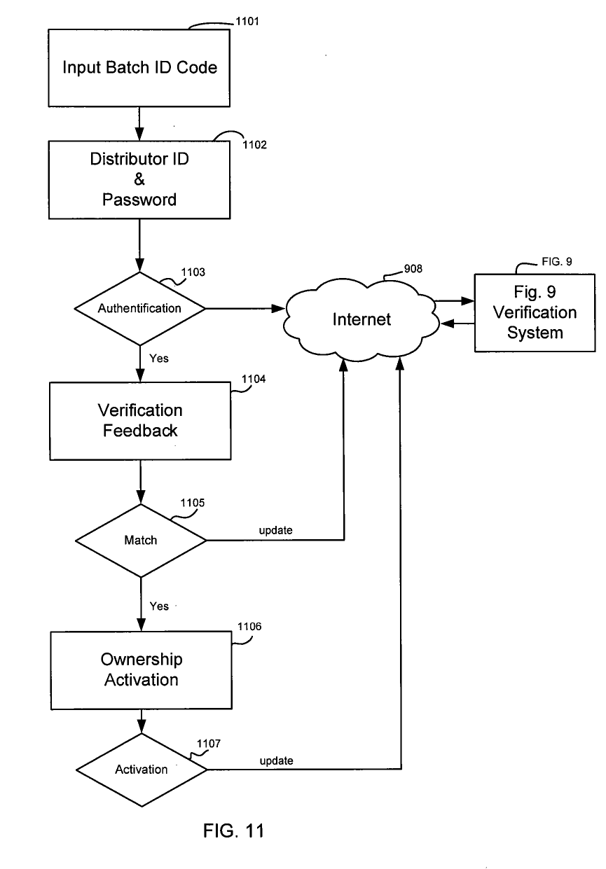

FIG. 9A shows the structural and functional modules of the verification system and channels. The object of the verification system is to provide various telecommunication channels for any allowed party to access relevant databases to verify PID codes and batch ID codes. Meanwhile, also through that telecommunication channels, the verification result may be returned to the allowed party. Optionally, at the backend, different functional modules that are connected to the databases may perform data manipulation and system administration functions.

(1) Verification System

The verification system, as FIG. 9A depicts, comprises the following major components, a backend functional and system administration module 901, a relational verification database 903, a call center 905, and Web servers 906. They may be linked together by data connection buses 902 and 904.

The backend function and system administration module 901 may be responsible for, including but not limited to, code generation, client management, system administration and most of the mentioned functions that are related to inputting, updating, reporting and managing the data stored into the relational databases 903. The relational database 903 comprises various databases recording PID codes, batch ID codes, distributors and retailers' information, batch distribution records and so on for verification.

The function of the call center module 905 is to facilitate access to verification relational database 903 using conventional telecommunication networks, voice and/or data, to perform verification functions. The call center module comprises (a) a conventional call center module 905, including an interactive voice response system 918, a Test-To-Speech module 917 and a telecom gateway to handle all incoming and outgoing calls from/to a Public Switch Transmission Network (PSTN) 907, plus a Voice Over Internet Protocol (VOIP) gateway and a server 916 that handles telecommunication by IP phones through the Internet connection 908. Also, the call center module may include a Short-Message-Signal (SMS) server 915 that handles SMS communication through the Internet 908.

Apart from the call center module, the Web server module 906 may handle verification communication and data updating and exchange through the Internet connection 908. For the sake of flexibility and scalability, data interaction and communication between the relational database module 903 and the call center 905/Web server 906 may be in form of TCP/IP protocol and Extensive Markup Language XML, so that it may not be necessary to put the modules together in one physical location.

(2) Verification Channels

The above mentioned verification system structure facilitates the handling of verification through various available communication channels, including the Internet, PSTN, telephones and mobile phones, SMS and proprietary-design verification terminals, among others.

Through the Internet connection 908, a computer 913 and a client server 914 may be connected to the Web server module 906 and then the relational database 903 to verify PID codes and batch ID codes. An IP phone 912 may be used with the Internet connection 908 to access the VOIP server/gateway 916 and then relational database 903 for verification.

Through a PSTN 907, a telephone 909 and mobile phone 910 may access the call center module 905 and initiate an interactive voice verification process.

Through the Internet connection 908, mobile phone SMS may also be used to verify a PID code and batch ID code, through accessing the SMS server 915 and then the relational database 903.

### Authentic Access Channels

(1) Separate Means to Publicize the Authentic Access Channels

As discussed above, systems of the present invention allow distributors, retailers and consumers to use Internet, telephone, SMS and other possible channels to verify if a product is genuine or a fake. Generally speaking, systems of this invention, allow a user to determine if an item is counterfeit or genuine utilizing an identifier (PID code for example) applied to the item. An access channel must exist which allows the user to connect to the system and apply the methods of this invention to determine if a product is genuine or a fake.

In connection with FIG. 9A, examples of access channels include dialing a specific telephone number; accessing a specific Internet URL, sending a SMS message to a specific destination or any other procedure known in the art that allows a user to connect to a system utilized for anti-counterfeit protection.

To make the system of this invention more robust, information of the channels may be communicated to the user utilizing public media or other processes that are separate from the products to be identified or any label, packaging or device containing or carrying the codes of this invention, thus preventing the counterfeiting of the access channel itself.

If the access channel for connecting to an anti-counterfeit system of this invention is communicated to a user of that system only on the items to be identified, then that system may be exposed to being counterfeited itself because a counterfeiter may produce a fake label that includes an ID code and a fake access channel that will connect the user to a counterfeit system which will then provide the user with misinformation which falsely indicates that the item is genuine when in fact it is fake.

By utilizing the method described in this invention for preventing the counterfeiting of an access channel used to connect to an anti-counterfeiting system, a user cannot be tricked into accessing or connecting to a fake anti-counterfeit system because the user is informed of the only valid access channel(s) via media or processes separate from the label, packaging, device or item containing the ID code.

(2) Public Declaration of Access Channels

An operator of an anti-counterfeit system of this invention may publicly declare a number of access channels and may also publicly declare that said access channels are the only means of connecting to the system for anti-counterfeit verification within a stated region. Non-exclusive examples of such a region include mainland China, New York City, worldwide, XYZ brand in Hong Kong.

Such public declarations not only make known to users of the system of this invention the only true access channels for connecting to the system, hence preventing said users from being tricked into connecting to a fake system through a misleading access channel, but also make known publicly to government and law enforcement officials the operator of the genuine access channels. The public declarations must be made through a credible means, such as, but not limited to, television, magazine, or newspaper advertising, government endorsement within a jurisdiction, or any other means which allows authorities and the public to know the individual or organization declaring the access channels.

Those who would attempt to connect users to a fake anti-counterfeit system are highly unlikely to publicize their actions because the individual or organization that is publicly declaring the access channel so that it is well known to the public and government and law enforcement officials.

### Double Authentication

FIG. 9B shows the operation process of a double authentication through accessing a verification system and databases according to this invention. The objective of the process is to enable the receiving or buying party of a product or object, in batch scale or in single unit packaging, to verify (1) the authenticity of the product or object and (2) the authenticity of the supplying source, during a transaction involving said product or object between the two parties. The advantage of the process is the enhanced credibility arising out of the double authentication and the independent and trustworthy third party for the authentic verification.

Double authentication means that the receiving or buying party to a transaction may verify both the identity/authenticity of a product involved in the transaction and the identity/authenticity of supplying party. The information resulting from the double authentication may also be very useful for tracing the distribution of the product. This may help prevent the protected product or object from undergoing unauthorized copying and dissemination.

Optionally, through the third independent party (e.g., the operator of the anti-counterfeit system), the supplying or selling party may provide trustworthy evidence to the buyer or receiving party that the product is genuine and he/she is the authentic owner of the product or object supplied. Meanwhile, the receiving or buying party may also be ensured from a trustworthy source, apart from the sending or selling party, that the product bought is genuine and is from an authentic supplying source, rather than only relying on trust in the selling party or judging based on the product/object's appearance or packaging.

(1) Double Authentication through Accessing Third Party Systems

In the foregoing there has been described a unique identifier of a unit product, such as, a PID code 104A/B or identifier of a batch of product, such as, a batch ID code 401/402, that may facilitate verification and identification of a product or an object.

There has also been described a batch ID code family tree/hierarchy to link the relationship between different products with respective PID codes within a batch packaging and a unique batch ID code for that batch, so that checking the batch ID code is equivalent to checking all PID codes 104A/B within that batch.

There have also been described authentic access channels to assure the receiving party that he/she is accessing an authentic anti-counterfeit system.

There has also been described a verification system as shown in FIG. 9A, which may be accessed by the publicized access channels and comprises various databases containing relevant anti-counterfeit information and applications that facilitate the verification.

On top of these facilities, double authentication may be executed through accessing a third party's system and database, as FIG. 9B depicts. As a unit of product/object or a batch of products/objects flow from brand/product owner 920 to Party A 921 and then from Party A 921 to Party B 922, the double authentication process may be executed between Party A and the verification system 905/906 and database 903, and between Party B 922 and the verification system 905/906 and database 903. The brand/product owner 920, Party A 921 and B 922 may be a business entity or an individual.

The double authentication process may be divided into two stages (a) from product/brand owner 920 to Party A 921 and (b) from Party A 921 to Party B 922.

Before the product/object or batch of products/objects flows from the owner 920 to Party A 921, the owner 920 registers the product information and corresponding PID code or batch ID code with the verification system 905/906 and thus database 903, allowing any approved parties, which may be an individual or business entity, to be eligible to access and verify the product/object with the identifier.

When Party A 921 receives the product/object or batch of objects bearing an identifier from the owner 920, Party A 921 may verify the authenticity of the product/object received by the following steps:
(i) Party A 921 accesses and submits the identifier of the product/object to be verified to the verification system 905/906 and database 903.
(ii) After the system 905/906 and database 903 verifies the authenticity of Party A 921 and the input identifier, the system 905/906 sends feedback with (a) the product information and (b) the ownership information of the product/object. Party A 921 may then compare the feedback information from the system 905/906 with the physical product/object and also check the ownership information with his knowledge of the owner 920. If both pieces of information match, it may be inferred that the product is genuine and is from an authentic supplying source.
(iii) Then Party A 921 effects the transaction with the owner 920 and then may claim ownership of the product/object by activating his/her ownership status to the system 905/906. The system 905/906 may register the information in the database 903, so that when another party later verifies the product/object with the said identifier, he/she may get the same product information plus the fact that the ownership of the product/object belongs to Party A 921.

In the second phase, i.e., from Party A to Party B as FIG. 9B depicts, when the product/object with the identifier mentioned above flows from Party A 921 to Party B 922, Party B 922 may verify the product/object received from Party A 921 through accessing the third-party anti-counterfeiting system by undergoing the same steps (i), (ii) and (iii).

This process need not be limited to two or three transaction parties. It may be carried on to another party, only when this party fulfils the verification criteria set by product/brand owner 920.

It is to be noted that in the above authentication process, in addition to information mentioned above, the anti-counterfeiting system may send feedback with a straightforward indication as to whether the product is fake or not, e.g., in the case, for example, where the database 903 does not have a PID code or batch ID code the buyer has input. Alternatively, the system may only provide searched information and leave the buyer to judge if the product is fake or not.

It can also be appreciated that if the buyer is an authorized distributor or retailer, he needs to input his login ID and password to activate ownership of the product. If the buyer is an individual consumer and is unlikely to re-sell the product, the activation process may not be necessary.

### Alternative Arrangements for Authentication Verification

In the embodiments above regarding double authentication, the receiving party may check the information it receives from the verification system with respect to both the product it plans to take in and the selling party. However, according to this invention, other arrangements are also contemplated.

As an alternative arrangement, the receiving party may opt to authenticate the product only. In this case, the verification system sends back only information about the product, exclusive of information about the selling party.

In the above embodiments, the verification system may provide quite a lot of detailed information of the product and the selling party, and the receiving party makes its own judgment as to whether the product is fake or genuine. As an alternative arrangement, the verification system may provide a direct answer as to whether the product is fake or genuine. For example, if the PID code is in the database of the verification system, the system may confirm that the product is genuine; otherwise, it may alert that the product may be fake.

### Batch ID Code Verification

The object of the batch ID code verification system and procedures is to enable any business entity or individual to verify the authenticity of a product on a batch scale instead of verifying a product, unit by unit. This batch scale verification system empowers authorized distributors and retailers to verify the authenticity of the product batch in order to prevent any undesirable items from infiltrating the authorized distribution chain. Optionally, the batch ID code verification procedure may be executed through the machine readable code scanner input 603, computer and Internet 908 connection, or manually by telephone, SMS or even through fax documents, among others. This arrangement enables distributors or retailers to verify the authenticity of the batch, even without a computer and the Internet connection 908. The discussion below explains how the system and procedures of various verification means and channels work.

(1) Batch ID Code Verification System

FIG. 10 shows the batch ID code verification system 1001. The system 1001 may be application software that is installed into a computer using an Internet connection. The object of the system 1001 is to make the verification process more efficient so that through the system 1001, users may access the third party verification system 906 and verification database 903 through an Internet connection or other possible connections known in the art.

The batch ID code verification system 1001 comprises four major modules, namely (1) a batch ID code input module 1002, (2) a batch ID code verification module 1003, (3) an ownership activation and exchange module 1004 and (4) a user login and account management module 1005. The function of the batch ID code input module 1002 is to allow users to input batch ID codes by scanning the batch ID codes in a machine readable format via a machine readable code scanner 603 connected to the computer. Alternatively, the batch ID code input process may also be handled manually through the module 1002.

The function of the batch ID code verification module 1003 is to facilitate the verification process after the batch ID code is inputted. The module 1003 may access the verification Web server 906 through the Internet and may submit required data to the system 906 and verification database 903. The module 1003 may also display the verification result feedback from the system 906/903.

The function of the ownership activation and exchange module 1004 is to confirm the activation of ownership of the batch verified that is finally proved to be authentic. Optionally, the module 1004 may also facilitate the release of ownership of any existing product batch that belongs to the user.

Finally the function of the user login and account management module 1005 is to provide a user login interface and to change the user information when needed.

Before the batch ID code verification system 1001 can function, the user may be required to activate the software 1001 during installation. The activation process may require the user to input the assigned login ID and password provided by the product/brand owner. Then the system may connect to the verification system 906/903 and may submit the login ID and password. Once the system 906/903 validates the login ID and password, it may demand the user to confirm the downloading of an electronic certificate to the installed computer. Through this installed electronic certificate, the system 906/903 may confirm the user's computer identity when the user's computer accesses the verification system 906/903 for the verification or ownership exchange procedure later. After the electronic certificate is installed, the batch ID code verification system 1001 may start to function.

(2) Machine Readable Batch ID Code Verification Process

FIG. 11 shows the batch ID code verification process. This verification procedure may be performed by those users who have installed the batch ID code verification system 1001, as depicted in FIG. 10. The batch ID code to be verified may be in a machine readable code format.

First the application system software 1001 is activated and turned on. The user inputs the batch ID code by scanning the batch ID code in the machine readable format through a machine readable code scanner, as step 1101 depicts. Then, as steps 1102 and 1103 indicate, the batch ID code verification system 1001 may send the input batch ID code along with the login ID, password and electronic certificate installed in the user's computer to the verification system depicted by FIG. 9A through the Internet 908.

If the login ID and password match with the electronic certificate, the verification system depicted in FIG. 9A verifies the inputted batch ID code, and may then send back the verification result to the user as process 1104 indicates. Then the user may match the feedback information against the information shown on the product packaging and invoice. If they match, then through the batch ID code verification module 1003, the user may send feedback regarding the matching result to the verification system so that the system updates the match result in the database 903. Thereby, the user may activate the ownership of the batch being verified through the ownership activation and exchange module 1004, as processes 1106 and 1107 depicts, and then may update the newly claimed ownership information to the verification system as depicted in FIG. 9A.

(3) Numeric Batch ID Code Verification Process

In case a distributor or retailer does not have a machine readable code scanner, computer, or Internet connection, he/she may still verify the batch ID code, through conventional telecom channels, telephone, mobile phone, and mobile SMS, or he/she may even utilize a paper document to verify a batch ID code.

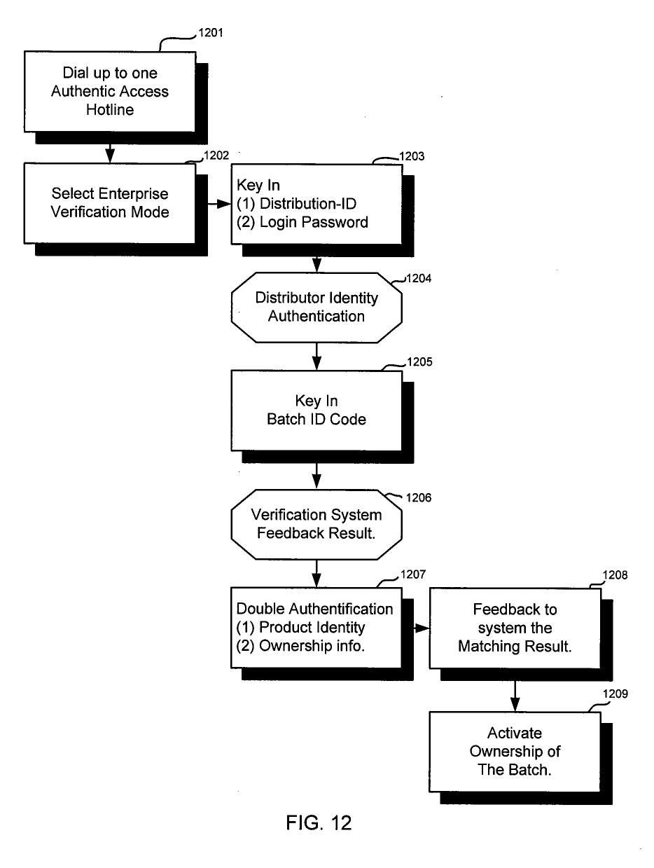

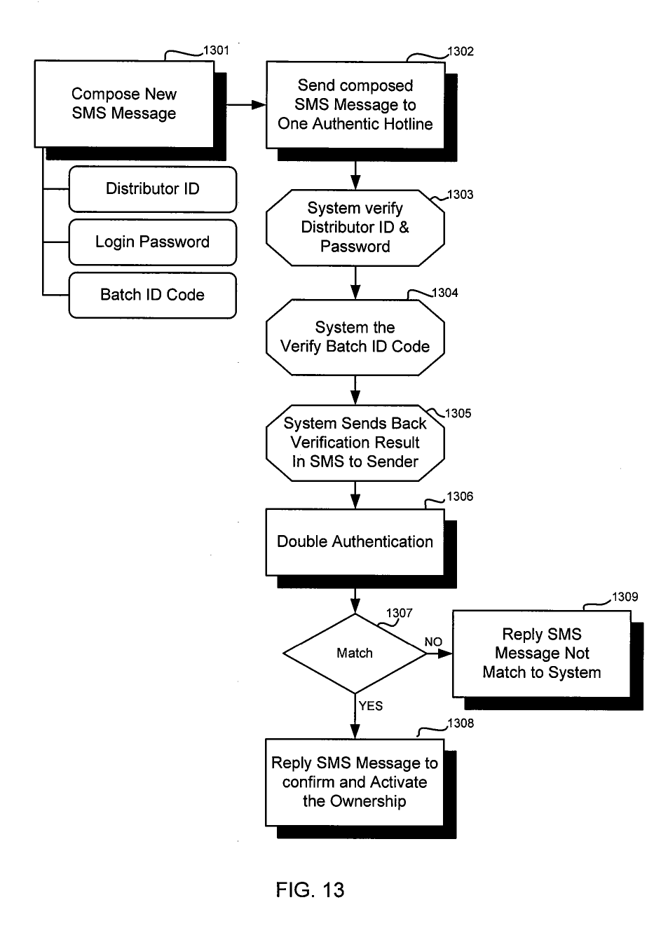

FIGS. 12 and 13 show the verification process for a batch ID code in numeric form through conventional telecom channels, telephone, and mobile phone SMS so that an authorized distributor or retailer may verify products on a batch scale as long as he/she can access a telecommunication means.

FIG. 12 shows the process of the batch ID code verification through PSTN telephone and mobile phone communication. At process 1201, the authorized distributor or retailer first accesses the verification system depicted in FIG. 9A, through dialing the access hotline telephone number. Then according to the voice instructions, he/she may be required to select enterprise verification mode by dialing a preset digit, from 0 to 9, as process 1202 indicates. After process 1202, the voice instruction of the verification system may ask him/her to dial in his assigned login ID and password at process 1203. After he/she has punched in the login ID and password, the verification system may verify the authenticity of the user at process 1204. After verifying the authenticity of the user, the verification system may ask the user to punch in the batch ID code shown on the batch ID code label at process 1205. According to the input batch ID code, the verification system searches its database 903 and sends feedback as to the verification result, and this feedback may include (a) product information and (b) ownership status of the batch ID code at process 1206.

Then the authorized user/distributor/retailer may execute a double authentication process as mentioned above at process 1207. Then he/she may send the verification result to the verification system at process 1208 and then activate the ownership of the verified batch ID code by following the voice instructions of the verification system.

FIG. 13 shows the process of batch ID code verification through SMS. According to the characteristic of SMS communication, the user/distributor/retailer first composes a new SMS message comprises three core pieces of information, (1) the assigned login ID, (2) the password, and (3) the batch ID code to be verified, at process 1301. Then he/she sends the composed SMS to the authentication hotline number, as process 1302 indicates. When the system depicted in FIG. 9A receives the SMS, the system first verifies the login ID and password, as process 1303 depicts. Once the login ID and password are confirmed, the system may verify the batch ID code against the database 903 and sends back the verification result back to the user/distributor/retailer by SMS, as processes 1304 and 1305 depicts.

When the user/distributor/retailer may receive the reply SMS, he may execute double authentication process as 1306 indicates. If the result matches, he/she may reply using a SMS to the system, to confirm the verification result and activate the ownership of the batch ID code, as processes 1307 and 1308 indicate. However, if the result does not match, the user/distributor/retailer may send a SMS to reflect the contradiction that implies counterfeiting, as processes 1307 and 1309 indicate.

The batch ID code may also be verified through sending a document to a verification center by fax or mail. The verification center may also have direct data connection with the verification system depicted in FIG. 9A so that the staff there may verify any incoming verification document.

There may be three document forms involved in the batch ID code verification process, (1) a batch verification form, (2) a verification result form and (3) a confirmation form, among others. (FIGS. 26-28.) The batch verification form 101 (FIG. 26) comprises columns/spaces for filling in (a) the batch sender's information, (b) the batch receiving party's information, (c) the batch receiving party's login ID and password as well as authorized signature, (d) the batch ID Code and quantity information and (e) the batch-receiving date and time, as well as verification date and time.

The verification result form 202 (FIG. 27) comprises columns/spaces/tables for displaying (a) the batch receiving party information, (b) batch verification result, including but not limited to, batch ID code against product information and current ownership status, (c) double authentication confirmation result and (d) ownership activation and exchange selection.

The confirmation form 303 (FIG. 28) may display information already confirmed, including but not limited to: (a) the receiving party information, (b) batch ID code verified and corresponding product information and ownership status, (c) ownership activation/release/exchange confirmation, (d) confirmation of verification result and (e) confirmation issued date and time.

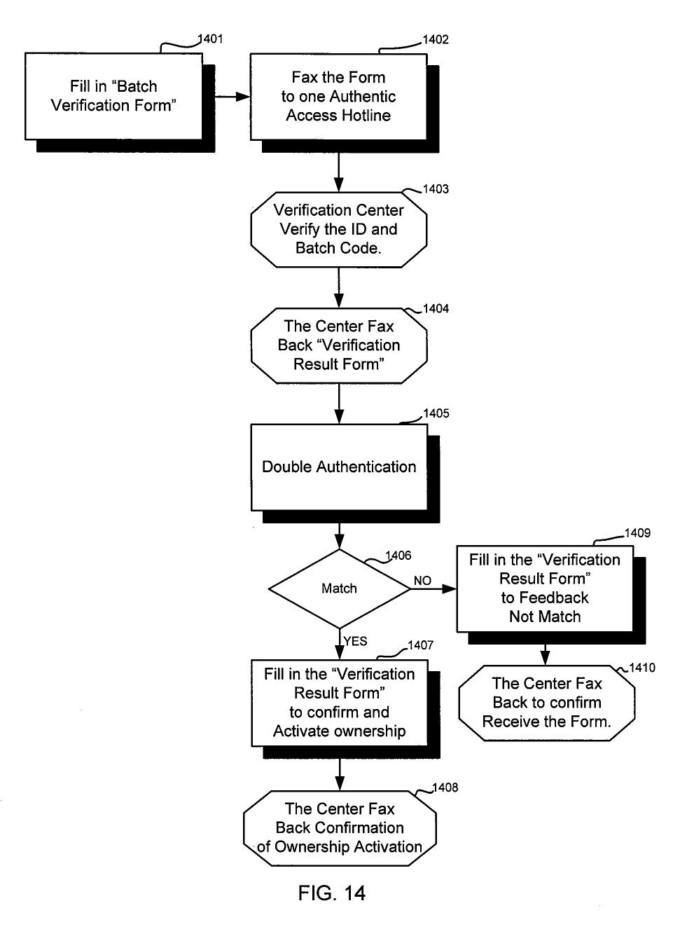

FIG. 14 shows a batch verification process by document transmission. As process 1401 depicts, when a user/distributor/retailer receives a product batch with a batch ID code label, he/she may fill in the batch verification form shown in FIG. 26 and send the filled form to a verification center by fax/mail/delivery, as process 1402 indicates. Once the verification center staff receives the form, they verify the batch receiving party identity and then the batch ID code filed as process 1403 depicts. Then the staff prints the verification result on a verification result form as shown in FIG. 27 and sends back the verification result form to the user/distributor/retailer as process 1404 depicts.

Once the user/distributor/retailer receives the verification result form, he/she may process double authentication as process 1405 depicts. If the information matches with the reality, he/she may fill out the received verification result form to confirm the verification result and activate the ownership, and send the verification result form back to verification center by fax/mail/delivery, as processes 1406 and 1407 depict. Then the verification center may send back a confirmation form as shown in FIG. 28 to confirm the ownership activation process to the user/distributor/retailer.

In case the verification does not match the reality, the user/distributor/retailer may also fill in the verification result form and send it back to the verification center and the verification center may also confirm the discrepancy in the verification result, as processes 1406, 1409 and 1410 depict.

### Batch Ownership Exchange

The objective of the ownership exchange function and process is to enable a party owning a batch of products to trade the product batch of which he/she has activated/claimed the ownership to another authorized party. Meanwhile the batch ownership exchange process enables the new receiving party to update the ownership status of the batch. This function enables an authentic product batch to be traded/redistributed among different authorized parties.

In order to prevent counterfeiting of the batch ID code label and unauthorized “parallel trading,” different authorized distributing parties may be assigned to different statuses according to a preset distribution hierarchy. And through assigning those authorized distribution parties to different statuses in the distribution hierarchy and setting different ownership exchange policies, the brand/product owner may restrict unauthorized parallel trading of his/her products among those authorized distributing parties.

(1) Distribution Layers, Hierarchy, and Policy

FIG. 15 shows a distribution hierarchy table. Various parties along the distribution chain may be divided into 5 or more distribution layers and hierarchy rankings, as necessary, that depend on the situation and the preference of the brand/product owner. The brand/product owner may categorize and assign each authorized party into a certain hierarchy ranking during the registration phase to facilitate this arrangement.

When products are distributed from a higher to a lower hierarchy ranking, for example from Layer 2, 2^{nd} Distributor (ranking 3) to Layer 3, wholesaler (ranking 2), the batch ownership may be activated/claimed during the batch ID code verification by the receiving party, Wholesaler.

If the product distribution is from a lower to a higher hierarchy ranking, such as from Layer 2, 2^{nd} Distributor (ranking 3) to Layer 1, Main Distributor (ranking 4) or is between the same hierarchy ranking, such as from a first Layer 3, Wholesaler (ranking 2) to a second layer 3, Wholesaler (ranking 2), then the sending/selling party of the batch should release the ownership he/she has activated/claimed before sending the batch to the receiving/buying party, so that the receiving/buyer party may activate the ownership. Otherwise ownership activation is not allowed and the verification process may be regarded as abnormal. The objective of such an arrangement is to alert to the situation where a batch ID code Label 501 may be counterfeit. Without a release action, ownership to the same batch ID code might be activated twice by two different parties within the same hierarchy ranking. Then the system may stop the 2^{nd} party from activating the ownership belonging to another party at the same ranking.

Optionally, the product/brand owner may assign a region code to each distribution party that fall into such geographical region, so that they may only trade/distribute product with those authorized parties within the same geographical region. This arrangement may limit unauthorized parallel import and cross regional distribution.

(2) Batch Ownership Exchange Process

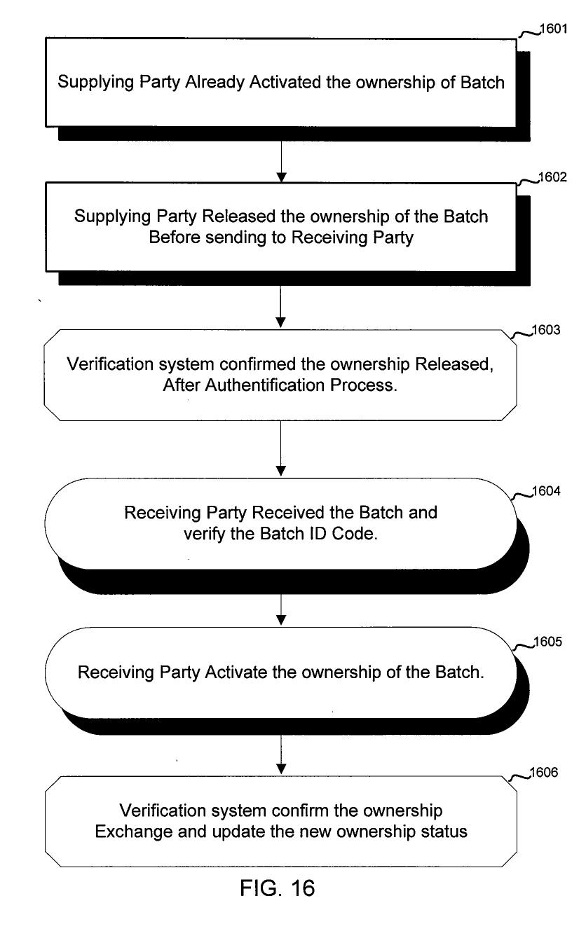

FIG. 16 shows the batch ownership exchange process. A product batch bearing a batch ID code label 501 and a batch ID code may be verified and the ownership of the batch may be activated/claimed by Party A, who is regarded as the supplying party as it is going to trade the batch to Party B who is regarded as receiving party, as process 1601 depicts.

Before the supplying party delivers the batch to the receiving party, the supplying party should release the formerly claimed ownership of the batch by (a) using the owner activation and exchange module 1004 of the application software 1001 installed into a computer with Internet connection to update the ownership status or (b) sending a verification result form 202 to the verification center by fax/mail/delivery, as process 1602 depicts.

Once the verification system as shown in FIG. 9A or the verification center receives the ownership release request, it may verify the received information and then confirm to the supplying party that the ownership is released as process 1603 depicts.

When the receiving party receives the batch and verifies the authenticity of the batch through the processes depicted in FIGS. 11, 12, 13 and 14, he/she may receive a feedback of the verification result, as process 1604 depicts. Then the receiving party may activate the ownership of the batch through the processes depicted in FIGS. 11, 12, 13 and 14, as process 1605 depicts.

Finally the verification system may confirm to the receiving party the claimed ownership as process 1606 depicts.

Alternatively to the above order, the ownership exchange process may also be executed in the order of 1601, 1604, 1602, 1603, 1605, and 1606. That is to say, the ownership release action and the authenticity verification action may be performed independently from each other.

### Product Ownership Registration & Exchange by Individual Consumers

In the forgoing there have been described processes in which a individual consumer may double authenticate a product and the seller and processes in which distributors/retailers exchange products, release ownership and register ownership. It is to be noted that according to this invention, individual consumers may also register ownership of products and exchange products.

As may be seen from the foregoing, the core principle of the whole verification system is to empower each party along the distribution chain, from product/brand owner, to distributor, to retailer and to consumer to perform double authentication for the product to be received/bought. As the product flows along the distribution chain, each party, either a distributor or a retailer, may verify and activate the ownership of the batch. Such product batch scale verification and ownership activation recordkeeping may have a direct impact on consumers' experience toward the verification of individual unit packed inside the batch. Consumer verification of the PID code of a unit product is the bottom line against counterfeit. Through this system a consumer may verify the product identity and authenticity at the retail sales point and, may optionally register ownership of the product.

(1) Product ID Double Authentication

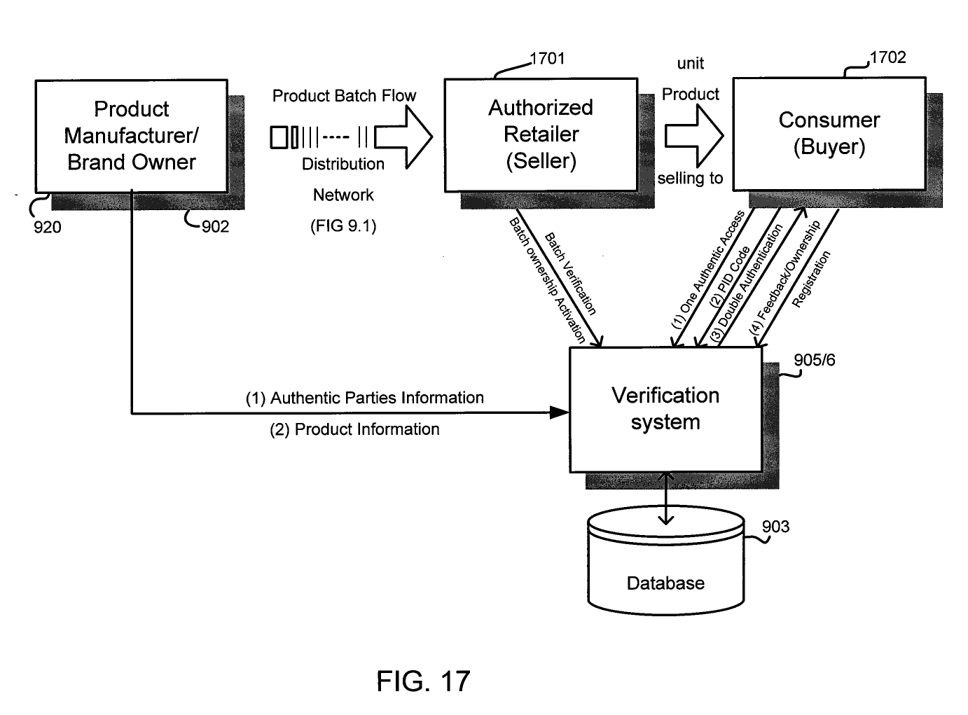

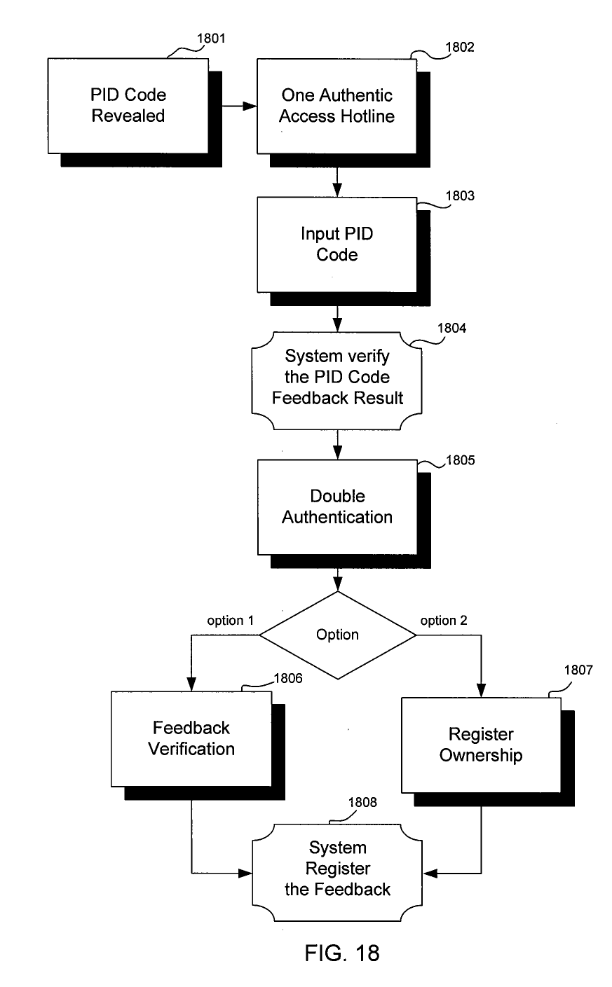

FIG. 17 shows the principle of PID double authentication through accessing a third party database system. The PID double authentication may be between a selling party or seller in its general meaning (including distributors, wholesalers, retailers and consumers) and a buying party or buyer 1702 in its general meaning (including distributors, wholesalers, retailers and consumers). The PID double authentication allows the buying party to access the verification system 905/906 and database 903 through an authentic access channel, inputting the PID code attached to the product to verify (1) the product identity and (2) the current ownership of the product. By comparing the feedback information with that printed on the product or with the physical characteristics of the product and with the seller's identity, the consumer knows that the product is authentic and from an authentic seller if the selling party 1701 has normally verified and activated the ownership of the product. Steps 1801-1805 in FIG. 18 describe this process.

In the case where the product/object being verified is genuine, the system may offer two options for the buyer to select. Option 1 is to send the verification result to the verification system without registering the ownership of the product/object as process 1806 depicts. Option 2 is to feed the verification result back to the verification system and also register the ownership of the product/object as processes 1806 and 1807 depict. Both options lead to the process that the verification system registers the final feedback result as process 1808 depicts.

The system may also enable a buyer to register the ownership of the product/object bought right at the point of sale or after he/she buys the product through the Internet or whatever way to register the ownership, so that anyone may verify that the object/product registered belongs to such a registered buyer.

The ownership registration process may be done right at the point of purchase. A salesperson may handle the registration process for the customer after the customer purchased the product. The salesperson may input (1) the PID code of the product, (2) the customer's identity information and (3) the identification of the point of purchase to the computer system of the point of sales and then, through Internet access, to the main verification system 905/906.

The verification system 905/906 may then verify (1) the authenticity of the point of purchase and (2) the availability and authenticity of the PID code and (3) whether the PID code belongs to that point of purchase. If all the verifications are successful, the verification system may update the customer ownership status in the database. Then the verification may generate a one-time-use identification code (ID) and password to the computer system at the point of purchase. Then the sales person may hand the ID and password to the customer. The customer may change the product ownership status once by this given ID and password.

Since normally an individual customer may not have a specialized software application, like the batch ID code verification system 1001 shown in FIG. 10, installed in his/her computer, he/she may also register ownership of a product he just bought through the Internet or by telephone, among others.

The ownership registration process may be done by the customer himself/herself, if he/she buys the product online or by physical exchange. Once he/she purchases the product online, the online store may release a one-time-use ID and password to the buyer along with the product delivery. He/she may register the ownership status by accessing the verification system 905/6 through an authentic access channel through Internet or telephone. When accessing the verification system 905/6, he/she may be required by the system 905/6 to input the ID and password, along with the PID code for ownership registration, provided that the ownership status of the product is vacant. Having verified and confirmed the PID code, the ID, and password for customer, the verification system may require the owner to input his identity information and select the way to receive a new one-time-use ID and a new password, whether by e-mail or SMS. Then he/she may receive the new one-time-use password and ID later. Meanwhile, the ID and password he/she has just used to initiate such ownership registration process expire and may not be used any more. The new ID and password may be used to release and exchange the ownership. Finally, the system may confirm the completion of the registration process and may update the customer owner status of the database 903.

Once the product ownership is registered, anyone who accesses the authentic access channel and inputs the PID code may receive feedback regarding (a) the product information, i.e., brand name, model number, serial number or any significant description or unique characteristic of the product, (b) from which retail shop or point of purchase, i.e., name and location of the shop, the product was purchased and (c) the ownership identity, i.e., the name of the owner. Then the owner of the product may prove to others that (1) the product is genuine (as product information matches with the product reality), (2) the product is from a legitimate or authentic retail store, and (3) the product is legitimately in his/her possession.

Such a registered ownership may be exchanged when two individual customers wish to do so for a certain reason. Such ownership exchange process may be done (1) at an authentic point of purchase or (2) through the Internet or by accessing an authentic access channel by phone, among others.

The new owner may bring along (1) the product itself with the PID code attached or/and any proof of product ownership, i.e., a product certificate that records all the necessary product information and (2) the new one-time-use ID and password the seller possessed by registering the product, and request the salesperson to update the new ownership status of the product. The process may be the same as depicted above. Then the product ownership may be updated and such new owner may receive another one-time-use password and ID for further change in ownership status.

Such ownership exchange process may also be done online or through telephone by accessing an authentic access channel. The former owner may offer the product along with his/her one-time-use ID and password to the new owner during the transaction. The buyer may verify the product and ownership authenticity through accessing an authentic access channel. After confirming the authenticity of the product, the new owner may update the ownership status.

### VOIP Authentication Using VoiceXML

As discussed above, telephones may be used in this invention for authentication purpose. For ordinary users, the system appears to be a traditional query system. The Interactive Voice Response Services (IVRS) technology has been used in a lot of query systems by PSTN telephones. Such systems need expensive interactive voice cards and entail expensive phone bills. In some cases, to reduce the cost, only one voice card is used, and consequently, the capacity of the system is very limited.

FIG. 19 shows a prior-art telephone query system. At the core of the system is a voice card 1907. A voice card cannot generate sound freely, but only replay pre-recorded, limited speeches. Because of the limit of the capacity of a voice card (16 lines at a maximum for most voice cards commercially available), if there are 200 incoming queries, more than ten voice cards would be needed and multiple computers would be needed to make the system function. The capacity is limited, the cost is high, and the maintenance is difficult.

As an alternative, Voice over IP (VOIP) phones may be used in place of PSTN telephones. FIG. 20 shows a process in which VOIP phones are used in a query system. An IP phone receives a voice signal 2001. The voice signal may be compressed into digital data 2002, and then encapsulated into TCP/IP packets 2003 for transmission over the Internet 1904 to a server. The server receives, opens, and de-encapsulates the packets 2004. The resultant digital data may be converted to a voice signal 2005. The voice signal may be passed to an IVRS voice card 2006 for conversion into digital data 2007. Then the data may be passed to a query database to perform the query. The response may be passed back to the IVRS card for voice synthesis, then for compression into digital data, encapsulation into packets, transmission over the Internet, de-encapsulation, and finally conversion back to voice signal for the IP phone to play for the inquirer.

It can be seen that in the above process, there are multiple times of compression, decompression, encapsulation, and de-encapsulation. The process is time-consuming, the response may be slow, and the efficiency may be low.

An embodiment of this invention contemplates the use of VoiceXML in the verification system when the receiving party in a transaction wishes to use IP phones to do the verification. It does not need a voice card to achieve functions like voice recognition and synthesis. The VoiceXML 1.0 Specification may be a W3C-based industrial standard and provides various APIs for developers, which are incorporated into this application by reference. It makes the underlying software and hardware transparent to the developers.

FIG. 23 shows a query system according to an embodiment of this invention. The core of the system may be a VoiceXML server or module 2301 and it further comprises a XML query system 2302, a query database 2303, a call center 2304, and a VOIP gateway 2305. Based on this system, FIG. 21 shows a query process illustrating the basic concept of this system.

In one embodiment, a digital command may be input at a query terminal (for example an IP phone) 2101. The command may be encapsulated into TCP/IP packets 2104, transmitted to a server via the Internet and then de-encapsulated 305 to regenerate the digital command. Then the digital command may be passed to the database for processing 2106. The database may retrieve a relevant text file 2107. The text file may be passed to a Text-to-Speech (TTS) module for conversion into a digital voice file 2108. The voice file may be encapsulated 2105, transmitted via the Internet, de-encapsulated and converted into an analogous voice signal 2109 which the inquirer can hear.

FIG. 22 shows a process applying the system of FIG. 23 to a verification mechanism of this invention. An inquirer picks up an IP phone (or uses a specialized terminal) and dials the number as the authentication access channel 2201. A signal may be transmitted to the VoiceXML server 2301. Then the inquirer may hear a voice prompt 2202 to input the PID code of the product or BID code of the batch of products he/she is going to buy and then confirms the input 2203. The server 2301 receives the input and issues instructions to the database. The server converts the data received from the database into a VoiceXML format, passes the converted data to a TTS module for synthesis to a voice signal, and plays the voice signal to the inquirer 2204. In cases where the inquirer needs to talk to staff, he/she may press “0” 2205 to connect to a call center and then start a bi-directional conversation with a staff 2206.

In an embodiment, as a general rule, when the inquirer inputs a command, the system may first analyze the command. If it is a single-digit input, the system may take it that the inquirer wishes to talk to a staff person. If it is a multiple-digit input, it may be recognized as an ordinary query and it may be passed to the VoiceXML server for further processing as discussed above.

FIG. 24 shows an embodiment of the VoiceXML server 2301 according to this invention. A gateway keeper 2401 provides an I/O interface and communication protocols between a VoiceXML interpreter and an IP phone. A VoiceXML interpreter 2402 parses and analyzes the XML documents, including checking their validity. If there are text-to-speech elements in the documents, they may be forwarded to a TTS module 2404 for processing. The TTS module 2404 may generate voices from VoiceXML documents. This may be done by extracting strings from the VoiceXML documents and sending them to a voice-generating engine to produce voice signals. An HTTP server module 2403 may retrieve VoiceXML files from a speech database and forward them to the VoiceXML interpreter for processing.

When the gateway keeper 2402 receives a TCP/IP packet from a LAN port, it may pass the data to the VoiceXML interpreter 2402. If the data is a single digit, the interpreter 2402 may instruct the HTTP server module 2403 to work or instruct the call center 2304 to connect to the IP address of the TCP/IP packet. Then the call center may conduct ordinary VOIP conversations with the inquirer. If the single digit stills requests a speech signal, the HTTP server module 2403 may retrieve a text file according to instructions from the interpreter 2402 and send the file to the interpreter. The interpreter 2402 may pass the file to the TTS module 2404 for conversion into a digital voice file. The gateway keeper 2401 may convert the digital voice file into TCP/IP packets and send them to the IP address of the inquirer.

If the interpreter decides the received data comprises multiple digits, it may be treated as an ordinary authentication verification request and the interpreter 2402 may pass the data to the query system 2302. The query system 2302 may process the digits, and retrieve relevant text files from the database (e.g., the database 311 shown in FIG. 3). The interpreter 2402 may send the files to the TTS module and then the files may be converted into voice signals for transmission to the inquirer.

FIG. 25 shows an exemplary operation process for a VoiceXML system as discussed above. At step 2501, the gateway keeper may receive a signal. The signal may be parsed and analyzed at step 2502. If the signal represents “0”, it may be forwarded to the call center at step 2513 so that the inquirer may talk to a staff person. Otherwise, the process may proceed to step 2503, where a pre-set piece of data may be retrieved from the internal database 2403 and forwarded to the TTS module which may process it to produce a voice signal (welcome signal) and send the signal to the inquirer.

After the inquirer hears the welcome signal, he/she may input a further piece of data. If this piece of data is again a one-digit command, it means that the inquirer may be requesting a pre-set function and it may be handled as in steps 2503 and thereafter. This one-digit input may be repeated for multiple times depending on the specific application and function configuration of the system. Otherwise, if the inquirer inputs a multiple-digit code, it may be treated as a PID code or BID code at step 2507. The query system or authentication system may process the code at step 2508. This includes a query of the database 2303 and retrieval of a text file from the database. The text file may be passed to the TTS module for conversion into a voice signal at step 2510. The voice signal may be encapsulated into TCP/IP packets at step 2511 and transmitted to the inquirer at step 2512. The process ends.

Obviously to a person of ordinary skill in the art, all or part of this invention may be implemented by computer systems. Such computer systems may be existing computer systems running computer programs designed according to this invention, a system comprising completely new hardware and software designed according to this invention, or a combination of existing hardware/software and new hardware/software designed according to this invention. Further, computer programs designed according to this invention may be carried out using known or future mediums, which when loaded to a computer system could cause the system to perform operations according to this invention.

While particular embodiments have been shown and described, it will be obvious to those skilled in the art that changes and modifications may be made without departing from this invention and its broader aspects and, therefore, the appended claims are to encompass within their scope all such changes and modifications as are within the true spirit and scope of this invention.

What is claimed is:

1. A system comprising:
a database comprising records with information of objects and records with ownership information of the objects; and
one or more servers coupled to the database, each of the servers being operable to receive information of an object which a first party wishes to buy from a second party, search the database with the information received from the first party, and, if a record with matching information is found in the database, send relevant information of the object associated with the record and ownership information associated with the record to the first party.

2. The system according to claim 1, the information sent by the first party to the system comprises a code attached to the object the first party wishes to buy.

3. The system according to claim 2, the object the first party wishes to buy is the smallest unit of a product, and the code is a unique Product ID (PID) code.

4. The system according to claim 3, the PID code consists of two parts, an open ID code which is always visible and a hidden ID code which is covered.

5. The system according to claim 2, the object the first party wishes to buy is a batch of products and the code is a unique batch ID (BID) code.

6. The system according to claim 1, the database further comprises:
a PID code database comprising records each of which has a unique code associated with an product as an object; and
a product identity database comprising records each of which is associated with a PID code and information associated with the product corresponding to the PID code.

7. The system according to claim 6, wherein:
the PID code database further comprises an open PID code database and a hidden PID code database which are linked to each other; and
each of the records in the product identity database is associated with an open PID code.

8. The system according to claim 6, wherein:
each record in the product identity database comprises ownership information and product information associated with the PID code associated with the record.

9. The system according to claim 8, wherein:
each record in the product identity database further comprises manufacturing information associated with the PID code associated with the record.

10. The system according to claim 1, the database further comprises:
a PID code database comprising records each of which has a unique code associated with an product as an object; and
a text file database comprising records each of which is associated with a PID code and text information associated with the product corresponding to the PIE) code.

11. The system according to claim 1, the database further comprises:
a PID code database comprising records each of which has a unique code associated with an product as an object; and
a voice file database comprising records each of which is associated with a PID code and voice information associated with the product corresponding to the PID code.

12. The system according to claim 6, further comprising:
a batch ID code database comprising records each of which comprises a unique batch ID (BID) code which corresponds to one or more PID codes; and
a distribution database comprising records each of which comprises ownership information corresponding to a BID code.

13. The system according to claim 1, wherein:
the database further comprises an authorized owner database comprising records each of which comprises information of a party that has successfully registered with the system, and
at least one of the servers is operable to receive registration applications from entities or individuals.

14. The system according to claim 1, wherein:
the first party decides if to buy the object or not based on the information received from one of the servers.

15. The system according to claim 14, wherein:
one of the servers is operable to update one or more records in the database to reflect the fact that the first party becomes the owner of the object he wishes to buy, if the first party judges that the object is genuine based on the information he received from one of the servers, decides to buy the object and sends this decision back to one of the servers.

16. The system according to claim 14, wherein:
one of the servers is operable to update one or more records in the database to reflect the fact that the object associated with the information sent from the first party may be fake or in abnormal possession, if the first party judges that the object is fake based on the information he received from one of the servers, decides not to buy the object and sends this decision back to one of the servers.

17. The system according to claim 1, wherein:
the communication between the servers and the first party is performed through Internet, SMS, telephone or mobile phone, or paper documents.

18. A method comprising:
receiving information of a object from a first party who wishes to buy the object from a second party;
searching a database with the information received from the first party for records comprising matching information, the database comprising records with information of objects and records with ownership information of the objects; and
if a record with matching information is found, sending to the first party relevant information of the object associated with the record and ownership information associated with the record.

19. The method according to claim 18, wherein the information sent by the first party comprises a code attached to the object the first party wishes to buy.

20. The method according to claim 19, the object the first party wishes to buy is the smallest unit of a product, and the code is a unique Product ID (PID) code.

21. The method according to claim 20, the PID code consists of two parts, an open ID code which is always visible and a hidden ID code which is covered.

22. The method according to claim 19, the object the first party wishes to buy is a batch of products, and the code is a unique batch ID (BID) code.

23. The method according to claim 18, further comprising:
receiving information from the first party comprising an indication that the object is genuine or fake; and
updating the ownership information of records in the database associated with object.

24. The method according to claim 18, further comprising:
receiving information from the first party comprising an indication that the object is genuine and the first party is going to buy the object as well as identity information of the first party; and
updating the ownership information of records in the database associated with object to reflect the fact that the first party becomes the owner of the object.

25. An article comprising a computer-readable medium recorded with instructions which, when executed by one or more computers, are able to cause the computers to perform the following operations:
receiving information of a object from a first party who wishes to buy the object from a second party;
searching a database with the information received from the first party for records comprising matching information, the database comprising records with information of objects and records with ownership information of the objects; and
if a record with matching information is found, sending to the first party relevant information of the object associated with the record and ownership information associated with the record.

26. The article of claim 25, wherein the instructions which, when executed by the one or more computers, are able to further cause the computers to perform the following operations:
receiving information from the first party comprising an indication that the object is genuine or fake; and
updating the ownership information of records in the database associated with object.

27. The article of claim 25, wherein the instructions which, when executed by the one or more computers, are able to further cause the computers to perform the following operations:
receiving information from the first party comprising an indication that the object is genuine and the first party is going to buy the object as well as identity information of the first party; and
updating the ownership information of records in the database associated with object to reflect the fact that the first party becomes the owner of the object.
